(19) United States
(12) Patent Application Publication
(10) Pub. No.: US 2026/0002531 A1
(43) Pub. Date: Jan. 1, 2026

(54) STUDS, ASSEMBLIES, AND METHODS PROVIDING ENHANCED RELIABILITY OF CONNECTIONS BETWEEN COMPONENTS IN HIGH-POWER PUMPS

(71) Applicant: Vulcan Industrial Holdings, LLC, Houston, TX (US)

(72) Inventors: Richard David Peer, Houston, TX (US); Chris Leake, Houston, TX (US)

(21) Appl. No.: 19/248,584

(22) Filed: Jun. 25, 2025

Related U.S. Application Data
(60) Provisional application No. 63/664,746, filed on Jun. 27, 2024.

(51) Int. Cl. F04B 53/16; F16B 35/04

(52) U.S. Cl. CPC F04B 53/16; F16B 35/04

(57) ABSTRACT

Studs, assemblies, and related methods may provide enhanced reliability of connections between components in high-power pumps. A stud may include a stud body having an anchor end positioned to be threadedly engaged with a fluid end block, and a fastener end positioned to be threadedly engaged with a fastener, thereby to secure the component and the fluid end block to one another. The stud body may include external anchor threads at the anchor end of the stud body having a buttress thread form, thereby to secure the anchor end of the stud body to the fluid end block. The stud body also may include external fastener threads at the fastener end of the stud body, and the external fastener threads may have a thread form different than the external anchor threads of the anchor end of the stud body.

### CROSS REFERENCE TO RELATED APPLICATIONS

This application claims priority to, and the benefit of U.S. Provisional Application No. 63/664,746, filed Jun. 27, 2024, titled “STUDS, ASSEMBLIES, AND METHODS PROVIDING ENHANCED RELIABILITY OF CONNECTIONS BETWEEN COMPONENTS IN HIGH-POWER PUMPS,” the disclosure of which is incorporated herein by reference in its entirety.

### TECHNICAL FIELD

The present disclosure relates to studs, assemblies, and methods providing enhanced reliability of connections between components in high-power pumps and, more particularly, to studs, assemblies, and methods providing enhanced reliability of connections between components and fluid ends of high-power pumps.

### BACKGROUND

Pumps may be used to transfer a fluid from one location to another location and, in some instances, at a greater pressure. Some types of pumps may be capable of significantly increasing the pressure of the pumped fluid, thereby subjecting components of the pump to high pressures during operation. For example, a chamber in the interior of a reciprocating pump may be exposed to high pressures as a plunger of the pump increases the pressure of the fluid in the chamber and discharges the fluid at the increased pressure from a discharge port. Some pumps may include one or more ports in fluid communication with the chamber. Some such ports may be closed by one or more components, and thus, the connections of such components to the pump may be required to withstand relatively high forces due to high pressures in the chamber during operation of the pump. For example, a cover used to close a port may be attached to the pump via fasteners to prevent the cover from being dislodged or separated from the pump when exposed to the high pressures and allowing the fluid to exit the chamber via the port in an unintended manner. In some instances, the fasteners may be unable to withstand the high pressures and may become damage or fail, potentially leading to shortened service lives of the cover and related components, as well as increased downtime, reducing the efficiency of operations using the pump.

An example high-power pump may be used to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high rates of flow and high pressures may result in significant wear to components associated with the fluid flow, such as high-power pumps used to pump the fracturing fluid. For example, fasteners and related assemblies that attach a cover received in a port of the pump may be unable to withstand forces caused by high pressures during operation of the pump. This may lead to premature damage to the fasteners or failure of the fasteners, thereby causing relatively more frequent maintenance, repair, or replacement, which may increase downtime for the hydraulic fracturing operation and reduce efficiency and productivity.

For at least these reasons, Applicant has recognized that it may be desirable to provide fasteners, related assemblies, and related methods resulting in enhanced reliability of connections associated with closing ports of a high-power pump and related assemblies that reduce downtime associated with use in a high-power pump. At least some examples described herein may address one or more of the above-noted potential issues, as well as possibly others.

### SUMMARY

As referenced above, it may be desirable to provide fasteners, related assemblies, and related methods that result in enhanced reliability, relatively longer service lives, and reduced downtime associated with use in a high-power pump, such as, for example, high-power pumps used in the oil and gas industry, where the operating conditions and fluids may present a particularly harsh environment. In some embodiments, the fasteners, related assemblies, and related methods presented herein may provide a relatively enhanced reliability, which may result in relatively reduced damage and failure rates and relatively increased component service lives. For example, in some embodiments, a fastener may include a stud having external threads at opposite ends of the stud, and the external threads of each end of the stud may have thread forms different from one another, which may result in increasing the reliability of the stud when used, for example, to connect components of a high-power pump to one another, such as, for example, components subjected to high pressure, such as a cover for closing a port of the pump.

According to some embodiments, a stud to enhance reliability of a connection between a component of a fluid end assembly and a fluid end block of the fluid end assembly, may include a stud body having a longitudinal stud axis extending between an anchor end positioned to be threadedly engaged with the fluid end block and a fastener end opposite the anchor end and positioned to be threadedly engaged with a fastener, thereby to secure the component and the fluid end block to one another. The stud body may include a shank extending between the anchor end and the fastener end. The stud body further may include external anchor threads at the anchor end of the stud body. The external anchor threads may have a buttress thread form positioned to engage internal threads of an anchor hole in the fluid end block having a complimentary internal buttress thread form, thereby to secure the anchor end of the stud body to the fluid end block. The stud body also may include external fastener threads at the fastener end of the stud body. The external fastener threads may have a thread form different than the external anchor threads of the anchor end of the stud body. The external fastener threads may be positioned to engage internal threads of a fastener having a thread form complimentary to the thread form of the external fastener threads of the fastener end of the stud body, thereby to enhance reliability of a connection between the component and the fluid end block.

According to some embodiments, a fluid end assembly for a high-power pump may include a fluid end block at least partially defining a chamber, an access port providing access to the chamber, and an anchor hole in an exterior face of the fluid end block and associated with the access port. The anchor hole may have internal threads having a buttress thread form. The fluid end assembly further may include a cover at least partially received in the access port. The fluid end assembly further may include an outer housing connected to the cover. The outer housing may have a housing hole extending through the outer housing. The fluid end assembly also may include a stud extending through the housing hole of the outer housing and into the anchor hole in the fluid end block. The stud may include a stud body having a longitudinal stud axis extending between an anchor end threadedly engaged with the internal threads of the anchor hole and a fastener end opposite the anchor end and positioned to be threadedly engaged with a fastener. The stud body may include a shank extending between the anchor end and the fastener end, and external anchor threads at the anchor end of the stud body. The external anchor threads may have a buttress thread form engaging the internal threads of the anchor hole of the fluid end block, thereby to secure the anchor end of the stud body to the fluid end block. The stud body further may include external fastener threads at the fastener end of the stud body. The external fastener threads may have a thread form different than the external anchor threads of the anchor end of the stud. The fluid end assembly further may include a fastener engaged with the fastener end of the stud body. The fastener may have internal fastener threads complimentary to the external fastener threads of the fastener end of the stud body, thereby to enhance reliability of a connection between the cover, the outer housing, and the fluid end block.

According to some embodiments, a high-power pump may include a power end positioned to convert power into reciprocating motion, and a plunger connected to the power end and positioned to reciprocate. The high-power pump further may include a fluid end assembly connected to the power end. The fluid end assembly may include a fluid end block at least partially defining a chamber, an access port providing access to the chamber, and an anchor hole in an exterior face of the fluid end block and associated with the access port. The anchor hole may have internal threads having a buttress thread form. The fluid end assembly further may include a cover at least partially received in the access port. The fluid end assembly further may include an outer housing connected to the cover. The outer housing may have a housing hole extending through the outer housing. The fluid end assembly also may include a stud extending through the housing hole of the outer housing and into the anchor hole in the fluid end block. The stud may include a stud body having a longitudinal stud axis extending between an anchor end threadedly engaged with the internal threads of the anchor hole and a fastener end opposite the anchor end and positioned to be threadedly engaged with a fastener. The stud body may include a shank extending between the anchor end and the fastener end, and external anchor threads at the anchor end of the stud body. The external anchor threads may have a buttress thread form engaging the internal threads of the anchor hole of the fluid end block, thereby to secure the anchor end of the stud body to the fluid end block. The stud body further may include external fastener threads at the fastener end of the stud body. The external fastener threads may have a thread form different than the external anchor threads of the anchor end of the stud. The fluid end assembly further may include a fastener engaged with the fastener end of the stud body. The fastener may have internal fastener threads complimentary to the external fastener threads of the fastener end of the stud body, thereby to enhance reliability of a connection between the cover, the outer housing, and the fluid end block.

According to some embodiments, a method of installing a cover in an access port of a fluid end block may include inserting a cover at least partially into an access port of a fluid end block, and positioning an outer housing adjacent an exterior face of the fluid end block and the cover. The method further may include passing an anchor end of a stud into a housing hole through the outer housing, and engaging external anchor threads of the anchor end of the stud with internal threads of an anchor hole in the exterior face of the fluid end block. The external anchor threads of the anchor end of the stud and the internal threads of the anchor hole having a buttress thread form. The method also may include engaging internal threads of a fastener with external fastener threads of a fastener end of the stud, thereby to connect the cover, the outer housing, and the fluid end block to one another. The external fastener threads of the fastener end of the stud may have a thread form different than the external anchor threads of the anchor end of the stud.

According to some embodiments, a method for enhancing reliability of a connection between a component of a fluid end assembly and a fluid end block of the fluid end assembly, may include separating each of a plurality of fasteners from each of a plurality of first studs connecting a component to a fluid end block of a fluid end assembly. Each of the plurality of first studs may have a first anchor end including first external anchor threads having a buttress thread form, and a first fastener end including first external fastener threads having a buttress thread form. The method further may include separating each of the plurality of first studs from each of a plurality of anchor holes in the fluid end block. Each of the anchor holes may include internal anchor threads having a buttress thread form. The method also may include engaging each of a plurality of second studs in one of the plurality of anchor holes in the fluid end block. Each of the plurality of second studs may have a second anchor end including second external anchor threads having a buttress thread form. Each of the plurality of second studs further may have a second fastener end including second external fastener threads having a thread form different than the second external anchor threads of the second anchor ends of each of the plurality of the second studs. The method further may include engaging each of a plurality of fasteners with a second fastener end of one of the plurality of second studs, thereby to enhance reliability of a connection between the component and the fluid end block.

In some embodiments, a method for retrofitting a fluid end block of a fluid end assembly may include separating each of a plurality of fasteners from each of a plurality of first studs connecting a component to a fluid end block of a fluid end assembly. Each of the plurality of first studs may have a first anchor end including first external anchor threads having a buttress thread form, and a first fastener end including first external fastener threads having a buttress thread form. The method further may include separating each of the plurality of first studs from each of a plurality of anchor holes in the fluid end block. Each of the anchor holes may include internal anchor threads having a buttress thread form. The method also may include engaging each of a plurality of second studs in one of the plurality of anchor holes in the fluid end block. Each of the plurality of second studs may have a second anchor end including second external anchor threads having a buttress thread form. Each of the plurality of second studs further may have a second fastener end including second external fastener threads having a thread form different than the second external anchor threads of the second anchor ends of each of the plurality of the second studs. The method further may include engaging each of a plurality of fasteners with a second fastener end of one of the plurality of second studs, thereby to enhance reliability of a connection between the component and the fluid end block.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1A is a schematic perspective section view of an example high-power pump including an example fluid end assembly, according to embodiments of the disclosure.

FIG. 1B is a schematic side section view of the example high-power pump shown in FIG. 1A, according to embodiments of the disclosure.

FIG. 1C is a schematic detailed side section view of a portion of the example high-power pump shown in FIG. 1A, including an example stud, according to embodiments of the disclosure.

FIG. 2 is a schematic side view of an example prior art stud including detailed views of opposite ends of the stud, each having an example buttress thread form.

FIG. 3 is a schematic side view of an example stud including detailed views of example different thread forms at opposite ends of the stud, according to embodiments of the disclosure.

FIG. 4A schematically depicts an example of removing example studs from a fluid end assembly.

FIG. 4B schematically depicts an example of installing example studs relative to an example fluid end assembly, according to embodiments of the disclosure.

FIG. 5 is a graph of testing results showing torque applied to a fastener versus preload achieved for a first set of sample studs having an example buttress thread form.

FIG. 6 is a graph of testing results showing torque applied to a fastener versus preload achieved for a second set of sample studs having an example UNR thread form, according to embodiments of the disclosure.

FIG. 7 is a graph showing a comparison of the testing results shown in FIGS. 5 and 6, respectively.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed fasteners, related assemblies, and related methods that result in enhanced reliability, relatively longer service lives, and reduced downtime associated with use in a high-power pump, such as, for example, high-power pumps used in the oil and gas industry, where the operating conditions and fluids may present a particularly harsh environment. In some embodiments, the fasteners, related assemblies, and related methods presented herein may provide connections having a relatively enhanced reliability, which may result in relatively reduced damage and failure rates and relatively increased service lives. For example, in some embodiments, the fastener may include a stud having external threads at opposite ends of the stud, and the external threads of each end of the stud may have thread forms different from one another, which may result in increasing the reliability of the stud when used, for example, to connect components of a high-power pump to one another, such as, for example, components subjected to high pressure, such as a cover for closing a port of the pump.

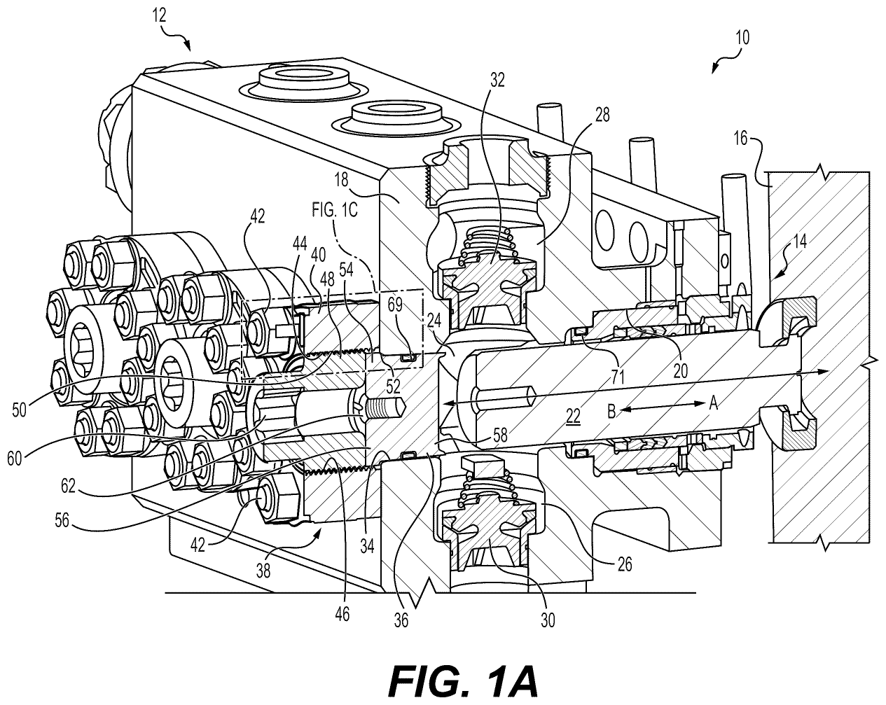

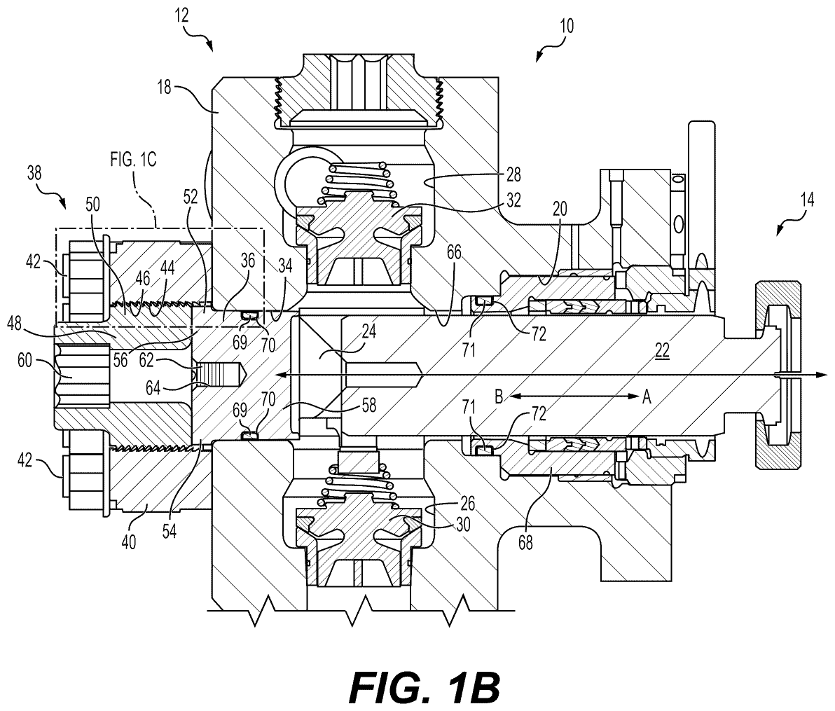

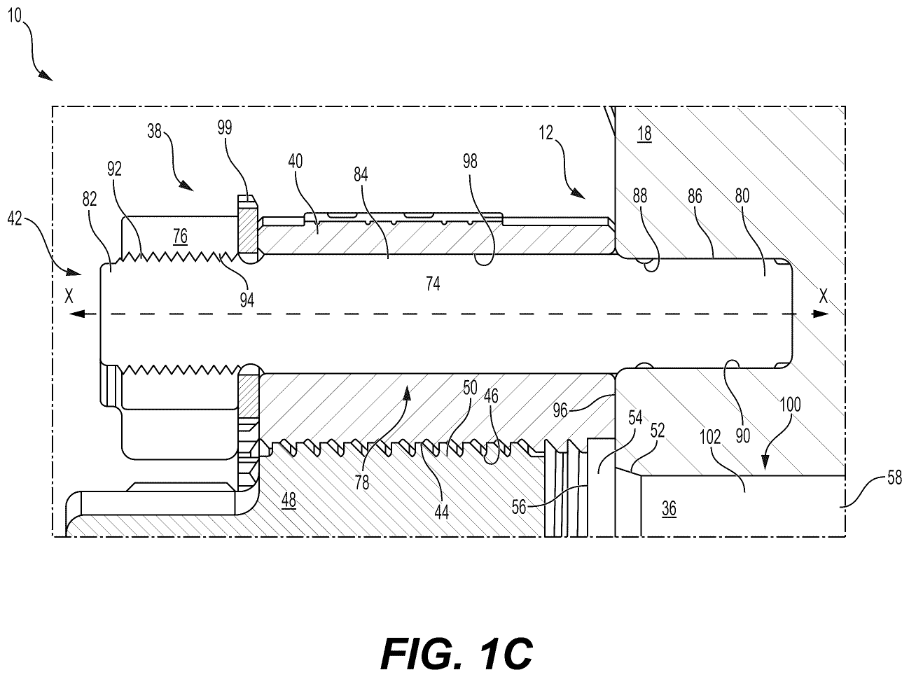

For example, FIG. 1A is a schematic partial perspective section view of an example pump 10, including an example fluid end assembly 12 and an example power end assembly 14 (only schematically depicted), according to embodiments of the disclosure. FIG. 1B is a schematic side section view of the example high-power pump 10 shown in FIG. 1A, and FIG. IC is a schematic detailed side section view of a portion of the example high-power pump 10 shown in FIG. 1A. The pump 10 may be any high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping hydraulic fracturing fluid. Although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1A, the example pump 10 may be a reciprocating plunger pump and may include the fluid end assembly 12 and the power end assembly 14 In some embodiments, the power end assembly 14 may include, for example, a housing 16 with mechanical power transmission components, such as a crankshaft, bearings supporting the crankshaft in the housing, crossheads, reduction gears, and/or connecting rods and plungers connected to the connecting rods. In some embodiments, the power end assembly 14 may be configured to convert power into reciprocating motion. For example, the power end assembly 14 may be configured to convert rotational power into reciprocating motion, or the power end assembly 14 may be configured to convert electric or hydraulic power into reciprocating motion.

As shown in FIGS. 1A and 1B, the fluid end assembly 12 may include, for example, a fluid end block 18 including one or more cylinders 20 in which respective plungers 22 reciprocate, one or more chambers 24 receiving fluid, one or more suction ports 26 for drawing fluid into the one or more chambers 24, and one or more discharge ports 28 for discharging fluid from the one or more chambers 24 at a higher pressure. For example, as each plunger 22, moved via operation of, for example, a crankshaft and a respective connecting rod of the power end assembly 16, at least partially retracts in direction A into a respective cylinder 20, fluid is drawn into the chamber 24 of the fluid end assembly 12 via the suction port 26 in the fluid end block 18 while an intake valve 30 is open and a discharge valve 32 is closed. As each plunger 20 extends back toward the chamber 24 in direction B, moved via operation of, for example, the crankshaft and the respective connecting rod of the power end assembly 16, pressurized fluid is discharged from the fluid end assembly 12 via the discharge port 28 in the fluid end block 18 while the discharge valve 32 is open and the intake valve 30 is closed. The intake valve 30 and discharge valve 32 may be one-way valves or check valves, allowing fluid to flow only in a single direction, either into the fluid end block 18 via the intake valve 30, or from the fluid end block 18 via the discharge valve 32. In this example manner, the fluid end assembly 12 draws fluid into the fluid end assembly 12 at a first pressure and discharges the fluid from the fluid end assembly 12 at a higher pressure. In some pump embodiments, the fluid end assembly 12 may include multiple (e.g., two, three, four, or five) sets of intake passages, cylinders, plungers, and discharge passages to pump fluid at high pressures and/or high flow rates. Other types of pumps, fluid end assemblies, and/or power end assemblies are contemplated.

As shown in FIGS. 1A and 1B, in some embodiments, the fluid end assembly 12 may include an access port 34 providing access to the chamber 24, for example, for use during assembly and/or maintenance of the fluid end assembly 12. The access port 34 may be selectively closed via a cover 36 received in the access port 34. In some embodiments, the access port 34 may be defined in the fluid end block 18 by a circular aperture having an interior face having a substantially cylindrical configuration, for example, as shown in FIG. 1A. In some embodiments, the cover 36 may have a substantially circular cross-section and may have a substantially cylindrical configuration sized and shaped to fit within the interior face of the access port 34, for example, as shown in FIGS. 1A and 1B. In some embodiments, the cover 36 may be sized and shaped to fit snugly within the access port 34.

In some embodiments, a retainer assembly 38 may be used to secure the cover 36 within the access port 34. As shown, in some embodiments, the retainer assembly 38 may include an outer housing 40 configured to be secured to an exterior surface of the fluid end block 18 adjacent the access port 34, for example, via one of more fasteners 42, for example, as described herein. The outer housing 40 may define a receiver aperture 44 provided with interior retainer threads 46. The retainer assembly 38 further may include a retainer 48, which may include a substantially cylindrical body having exterior retainer threads 50 configured to threadedly engage the interior retainer threads 46 of the outer housing 40. In some embodiments, the cover 36 may include a shoulder 52 and a flange 54 having an exterior end 56 opposite an interior end 58 facing the chamber 24. The shoulder 52 and flange 54 may be configured to abut the exterior surface (sec, e.g., exterior face 96 in FIG. 1C) of the fluid end block 18 adjacent the access port 34. The retainer 48 may be threaded into the outer housing 40 and abut the exterior end 56 of the cover assembly 36, thereby to secure the cover assembly 36 in the access port 34. As shown, in some embodiments, the retainer 48 may include a retainer recess 60 configured to be engaged by a tool for assisting the tightening and loosening of the retainer 48 relative to the outer housing 40 and the cover assembly 36.

As shown in FIGS. 1A and 1B, some embodiments of the cover 36 may include a cover recess 62 opening outward from the center of the exterior end 56 of the cover 36 surface and having interior threads 64 (FIG. 1B). The cover recess 62 may be used to assist within removal of the cover 36, for example, to provide access to the chamber 24. For example, a tool may be used to engage the cover recess 62 (e.g., via the interior threads 64) and assist with pulling the cover 36 from the access port 34.

As shown in FIGS. 1A and 1B, in some embodiments, the fluid end block 18 may include a plunger port 66 and a sleeve 68 received in the plunger port 66. The plunger port 66 and the sleeve 68 may be substantially cylindrical, with the plunger port 66 having a substantially circular cross-section and the sleeve 68 having a substantially cylindrical outer surface received in the plunger port 66. The sleeve 68 may be configured to at least partially receive therein the plunger 22 as the plunger 22 reciprocates, thereby to draw fluid into the chamber 24 at a first pressure via the suction port 26 during movement of the plunger 22 in the first direction A and discharge the fluid from the chamber 24 at a second pressure greater than the first pressure via the discharge port 28 during movement of the plunger 22 in the second direction B, for example, as shown in FIGS. 1A and 1B.

As shown in FIGS. 1A and 1B, an annular seal 69 may be provided between the interior surface of the access port 34 and an exterior surface of the cover 36, thereby to provide a fluid seal between the access port 34 the cover 36 when the cover 36 is received in the access port 34. For example, as shown, the cover 36 may include on the outer cylindrical surface thereof an annular groove 70 (FIG. 1B), and the seal 69 may be at least partially received in the annular groove 70.

As shown in FIGS. 1A and 1B, an annular seal 71 may be provided between the interior surface of the plunger port 66 and an exterior surface of the sleeve 68, thereby to provide a fluid seal between the first and second components, for example, the plunger port 66 and the sleeve 68, when the sleeve 68 is placed in the plunger port 66. For example, as shown, the sleeve 68 may include on the outer cylindrical surface thereof an annular groove 72 (FIG. 1B), and the seal 71 may be at least partially received in the annular groove 72.

In some embodiments, as shown in FIG. 1C, one or more of the fasteners 42 may include a stud 74 and a fastener 76 engaging the stud 74, such as, for example, a nut. In some embodiments, the stud 74 may enhance the reliability of the connection between a component of a fluid end assembly 12 and a fluid end block 18 of the fluid end assembly 12, for example, as described herein. For example, the component may be a cover configured to close a port in a fluid end block, such as, the cover 36 closing the access port 34 of the fluid end block shown in FIGS. 1A-1C. Other components, including other covers and other ports, are contemplated.

As shown in FIG. IC, in some embodiments, the stud 74 may include a stud body 78 having a longitudinal stud axis X extending between an anchor end 80 positioned to be threadedly engaged with the fluid end block 18, and a fastener end 82 opposite the anchor end 80 and positioned to be threadedly engaged with a fastener, for example, the fastener 76, thereby to secure the cover 36 and the fluid end block 18 to one another. In some embodiments, the stud body 78 may include a shank 84 extending between the anchor end 80 and the fastener end 82. The stud body 78 further may include external anchor threads 86 at the anchor end 80 of the stud body 78. In some embodiments, the external anchor threads 86 may have a buttress thread form configured to engage internal threads 88 of an anchor hole 90 in the fluid end block 18 having a complimentary internal buttress thread form, thereby to secure the anchor end 80 of the stud body 78 to the fluid end block 18. As shown in FIG. 1C, in some embodiments, the stud body 78 also may include external fastener threads 92 at the fastener end 82 of the stud body 78. In some embodiments, the external fastener threads 92 may have a thread form different than the external anchor threads 86 of the anchor end 80 of the stud body 78. In some embodiments, the external fastener threads 92 may be configured to engage internal threads 94 of the fastener 76, which may have a thread form complimentary to the thread form of the external fastener threads 92 of the fastener end 82 of the stud body 78, thereby to connect the cover 36 to the fluid end block 18. In some embodiments, the external fastener threads 92 having a thread form other than a buttress thread form may result in increasing the reliability of the connection between, for example, the cover 36 and the fluid end block 18, as described herein.

In some embodiments, the external fastener threads 92 may include a thread form according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) the Deutsches Institut für Normung (DIN) standard; or (c) the American Petroleum Institute (API) standard. For example, in some embodiments, the external fastener threads 92 may include a thread form according to one or more of UN thread form or UNR thread form as defined by one or more of the ANSI or the ASME. Other non-buttress thread forms are contemplated.

In some embodiments, the shank 84 may include: (a) a full-bodied shank, for example, having a shank diameter substantially equal to a major thread diameter of one or more of the external anchor threads 86 or the external fastener threads 92, or (b) an undercut shank, for example, having a shank diameter substantially equal to or less than a pitch diameter of one or more of the external anchor threads 86 or the external fastener threads 92. Other configurations of the shank 84 are contemplated.

As shown in FIGS. 1A and 1B, in some embodiments, the fluid end assembly 12 may include the fluid end block 18, which may at least partially define the one or more chambers 24, and one or more access ports 34 providing access to the one or more chamber 24. As shown in FIG. 1C, the fluid end block 18 further may at least partially define one or more anchor holes 90 in an exterior face 96 of the fluid end block 18 and associated with (e.g., adjacent and/or encircling) each of the one or more access ports 34. In some embodiments, each of the one or more anchor holes 90 may have internal threads 88 having a buttress thread form. Other thread forms are contemplated.

In some embodiments, the fluid end assembly 12 further may include one or more covers 36, each configured to be at least partially received (e.g., fully received) in one of the access ports 34. As shown in FIGS. 1A-1C, in some embodiments, the fluid end assembly 12 also may include one or more outer housings 40 connected to each of the one or more covers 36. The one or more outer housings 40 each may include a plurality of housing holes 98 extending through the respective outer housing 40. In some embodiments, a stud 74 may extend through each of the housing holes 98 of a respective outer housing 40 and into a respective anchor hole 90 in the fluid end block 18.

As shown in FIG. IC, the stud body 78 of each stud 74 may extend between the anchor end 80, which is threadedly engaged with the internal threads 88 of the anchor hole 90 and the fastener end 82 opposite the anchor end 80, and which is threadedly engaged with one of the fasteners 76. For example, the external anchor threads 86 may have a buttress thread form engaging the internal threads 88 of the anchor hole 90 of the fluid end block 18, which may have a complimentary internal buttress thread form, thereby to secure the anchor end 80 of the stud 74 to the fluid end block 18. The external fastener threads 92 may have any thread form different than the external anchor threads 86, and the external fastener threads 92 may engage the internal threads 94 of the fastener 76, which may have a thread form complimentary to the thread form of the external fastener threads 94 of the stud 74, thereby to connect the cover 36 to the fluid end block 18. In some embodiments, a washer 99 may be provided between each of the fasteners 76 and the outer housing 40, for example, as shown in FIG. 1C.

As shown in FIGS. 1A-1C, each of the outer housings 40 may at least partially define a retainer aperture 44, and the fluid end assembly 12 further may include a retainer 48 at least partially received (e.g., fully received) in each of the retainer apertures 44, thereby to abut the respective exterior ends 56 of the respective covers 36, so as to secure the covers 36 at least partially in the respective access ports 34. For example, the retainer apertures 44 may each include interior retainer threads 46, each of the retainers 48 may include exterior retainer threads 50, and each of the retainers 48 may be secured in a respective retainer aperture 44 via threaded engagement between the interior retainer threads 46 and the exterior retainer threads 50.

As shown in FIG. 1C, in some embodiments, each of the covers 36 may include a cover body 100, and the cover body 100 may include a port engaging portion 102, with the flange 54 of the cover 36 extending radially outward from the port engaging portion 102 at the exterior end 56 of the cover 36, and the shoulder 52 being between an interior side of the flange 54 and the port engaging portion 102.

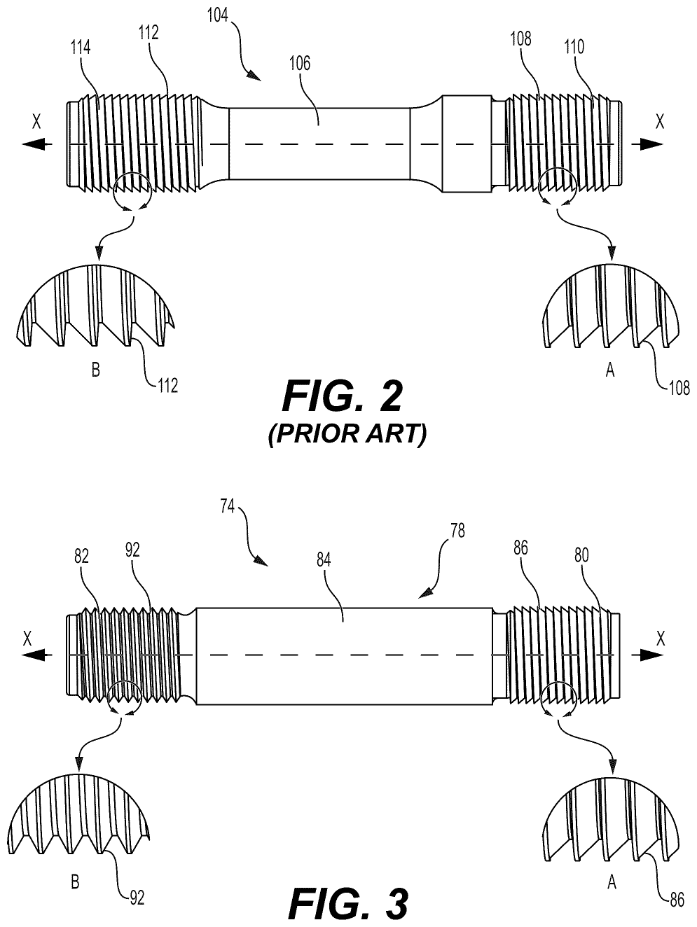

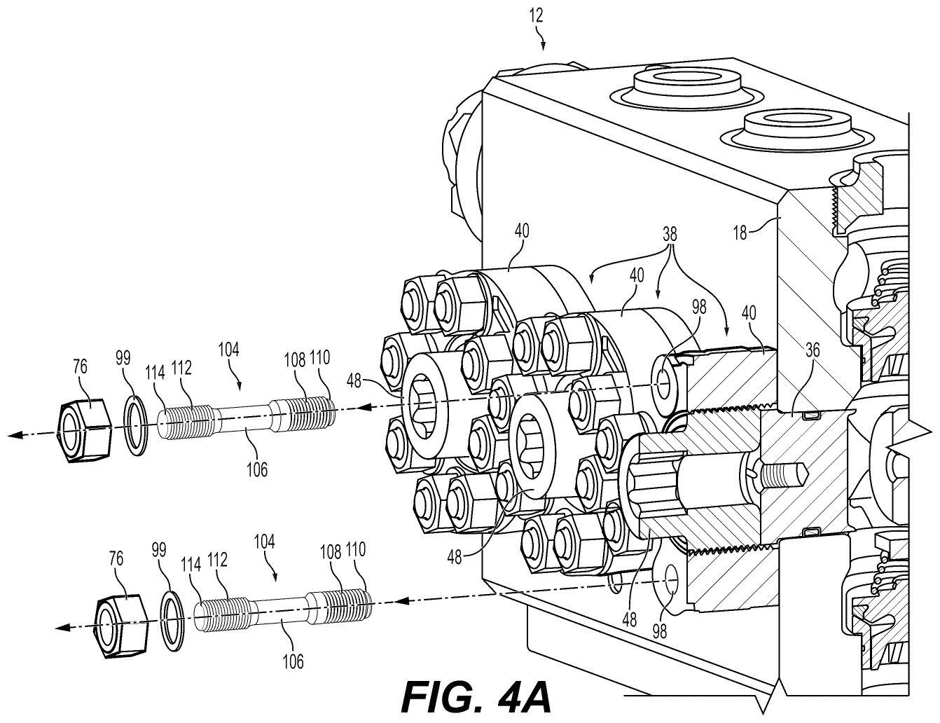

FIG. 2 is a schematic side view of an example prior art stud 104 including detailed views A and B of opposite ends of the stud 104, each having an example buttress thread form. FIG. 3 is a schematic side view of an example stud 74, according to embodiments of the disclosure, including detailed views A and B of example different thread forms at opposite ends of the stud 74.

As shown in FIG. 2, the example prior art stud 104 includes a shank 106 and first external threads 108 at a first end 110 and second external threads 112 at a second end 114 opposite the first end 110 of the prior art stud 104. As shown detail views A and B of FIG. 2, each of the first external threads 108 and the second external threads 112 has a buttress thread form. Thus, when used to connect a component of a fluid end assembly, for example, one end of the prior art stud 104 may be engaged with, for example, holes in a fluid end block. Because both the first external threads 108 and the second external threads 112 of the prior art stud 104 have a buttress thread form, the hole in the fluid end block will also include a complimentary buttress thread form. The opposite end of the prior art stud 104 will engage internal threads of a fastener in order to connect the component to the fluid end block. Because both the first external threads 108 and the second external threads 112 of the prior art stud 104 have a buttress thread form, the internal threads of the fastener will also have a complimentary buttress thread form.

Applicant has surprisingly found that prior art studs consistent with the example prior art stud 104 shown in FIG. 2, for example, may often provide a less reliable connection than desired between the component and the fluid end block. For example, Applicant has surprisingly found that studs having external threads with a buttress thread form at both ends may suffer from unexpected damage or failure when used to connect, for example, a component to a fluid end block. Without wishing to be bound by theory, Applicant has surprisingly found that, for example, during connection and/or installation of the component to a fluid end block, studs having external threads with a buttress thread form at both ends may often be under-preloaded (or over-preloaded) when fasteners (e.g., nuts) are engaged with the external threads of the stud at the opposite end from the end received in the hole in the fluid end block. For example, Applicant has surprisingly found that the amount of preload on such a stud may vary greatly for a given torque to which the fastener is tightened on the end of the stud receiving the fastener. In some instances, the amount of preload on the stud may vary as much as, for example, 50% for a given torque. As a result, the amount of preload may be insufficient or too great. When an insufficient preload has been applied to the stud during connection and tightening of the fastener to the stud, the fastener may be relatively loose, and the stud may become damaged or fail prematurely due, for example, to unexpected levels of fatigue. When too much preload has been applied to the stud during connection and tightening of the fastener to the stud, the stud may be stretched beyond its yield limit, and the stud may become damaged or fail prematurely due to, for example, fracture. In either instance, the reliability of the connection between the component and the fluid end block may be compromised, resulting in premature damage or failure of the stud.

As shown in FIG. 3, in some embodiments according to the disclosure, the stud 74 may include external threads at each end of the stud that have different thread forms. For example, the anchor end 80 of the stud 74 may be configured to be threadedly engaged with the fluid end block 18, and the fastener end 82 of the stud 74 opposite the anchor end 80 may be configured to be threadedly engaged with the fastener 76 (see FIG. 1C), thereby to secure a component (e.g., a cover) and the fluid end block to one another. As shown in detail A of FIG. 3, in some embodiments, the external anchor threads 86 may have a buttress thread form configured to engage internal threads of an anchor hole in the fluid end block having a complimentary internal buttress thread form, thereby to secure the anchor end 80 of the stud 74 to the fluid end block. Other thread forms are contemplated for the external anchor threads 86, depending, for example, on the thread form of the internal threads of the anchor hole. As shown in detail B of FIG. 3, in some embodiments, the external fastener threads 92 of the stud 74 may have a thread form different than the thread form of the external anchor threads 86 of the stud 74. In some embodiments, the external fastener threads 92 may be configured to engage internal threads of a fastener, which may have a thread form complimentary to the thread form of the external fastener threads 92 of the stud 74, thereby to connect the fastener 76 and the component (e.g., a cover) to the fluid end block. In some embodiments, the external fastener threads 92 may have any thread form other than a buttress thread form. The non-buttress thread form of the external fastener threads 92 may result in increasing the reliability of the connection between, for example, a component (e.g., a cover) and the fluid end block.

Applicant has surprisingly found that a stud having at least some thread forms other than a buttress thread form, when used as the external fastener threads 92, may provide a relatively more reliable connection. Without wishing to be bound by theory, Applicant has surprisingly found that, for example, during connection and/or installation of a component to a fluid end block, a stud consistent with embodiments described herein, having external fastener threads that differ from a buttress thread form, may often be more consistently pre-loaded, such that the stud is not unexpectedly subjected to fatigue failure or yield and facture due to improper preloading (e.g., insufficient preloading or excessive preloading). For example, Applicant has surprisingly found that at least some thread forms other than a buttress thread form may provide a more consistent level of preload for a given torque to which the fastener is tightened on the end of the stud receiving the fastener. In some instances, the amount of pre-load on the stud may vary as little as, for example, 5%. As a result, the desired amount preload may be more consistently achieved, resulting in a more reliable connection between a component (e.g., cover) and a fluid end block.

According to some embodiments, a method of installing a cover in an access port of a fluid end block may include inserting a cover at least partially into an access port of a fluid end block. The method, in some embodiments, further may include positioning an outer housing adjacent an exterior face of the fluid end block and the cover, and passing an anchor end of a stud into a housing hole through the outer housing. The method also may include engaging external anchor threads of the anchor end of the stud with internal threads of an anchor hole in the exterior face of the fluid end block. In some embodiments, the external anchor threads of the anchor end of the stud and the internal threads of the anchor hole may have a buttress thread form. The method further may include engaging internal threads of a fastener with external fastener threads of a fastener end of the stud, thereby to connect the cover, the outer housing, and the fluid end block to one another. The external fastener threads of the fastener end of the stud may have a thread form different than the external anchor threads of the anchor end of the stud.

In some embodiments, the method of installing a cover further may include passing a retainer at least partially into a retainer aperture of the outer housing, thereby to abut an exterior end of the cover so as to secure the cover at least partially in the access port. For example, passing the retainer at least partially into the retainer aperture may include engaging exterior retainer threads of the retainer with interior retainer threads in the retainer aperture.

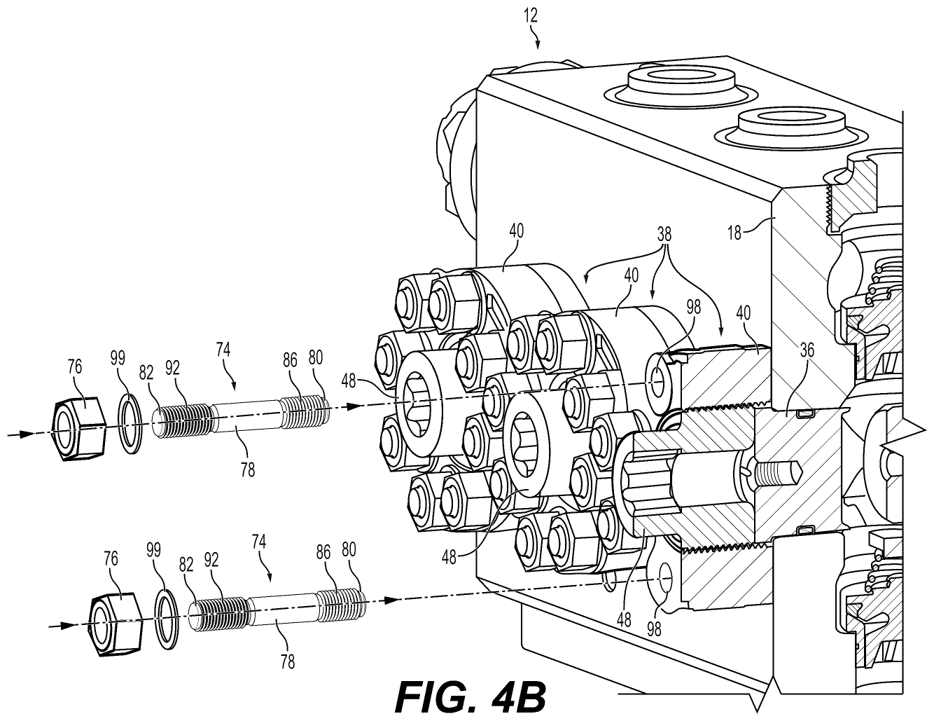

FIG. 4A schematically depicts an example of removing example studs 104 (e.g., example studs consistent with the example stud 104 shown in FIG. 2) from a fluid end assembly 12. FIG. 4B schematically depicts an example of installing example studs 74 (e.g., example studs consistent with the example studs 74 shown in FIG. 3, according to embodiments of the disclosure) relative to an example fluid end assembly, according to embodiments of the disclosure.

According to some embodiments, for example, as shown in FIGS. 4A and 4B, a method for enhancing reliability of a connection between a component of a fluid end assembly 12 and a fluid end block 18 of the fluid end assembly 12, may include separating each of a plurality of fasteners 76 from each of a plurality of first studs 104 connecting a component to a fluid end block 18 of a fluid end assembly 12, as shown in FIG. 4A. In some embodiments, each of the plurality of first studs 104 may have a first anchor end 110 including first external anchor threads 108 having a buttress thread form, and a first fastener end 114 including first external fastener threads 112 having a buttress thread form. The method further may include separating each of the plurality of first studs 104 from each of a plurality of anchor holes 90 in the fluid end block 18 (see, e.g., FIG. 1C). In some embodiments, each of the anchor holes 90 may include internal anchor threads 88 having a buttress thread form. As shown in FIG. 4B, the method also may include engaging each of a plurality of second studs 74 (see FIG. 3) in one of the plurality of anchor holes 90 in the fluid end block 18. In some embodiments, each of the plurality of second studs 74 may have a second anchor end 80 including second external anchor threads 86 having a buttress thread form, and a second fastener end 82 including second external fastener threads 92 having a thread form different than the second external anchor threads 86 of the second anchor ends 80 of each of the plurality of the second studs 74. The method further may include engaging each of a plurality of fasteners 76 with a second fastener end 82 of one of the plurality of second studs 74, thereby to connect the component and the fluid end block 18 to one another.

In some embodiments, a method for enhancing the reliability of a connection between a component of a fluid end assembly 12 and a fluid end block 18 further may include, before separating each of the plurality of fasteners 76 from each of the plurality of first studs 104, separating a retainer 48 preventing the component (e.g., a cover 36) from becoming separated from the fluid end block 18 from an outer housing 40 engaged with the retainer 48 and the fluid end block 18. In some embodiments, the method also may include, after separating each of the plurality of fasteners 76 from each of the plurality of first studs 104, sliding the outer housing 40 off the first studs 104, thereby to separate the outer housing 40 from the fluid end block 18. In some embodiments, the method further may include, before engaging each of the plurality of second studs 74 in one of the plurality of anchor holes 90 (FIG. 1C), separating the component from the fluid end block 18. In some embodiments, the component may include a cover (e.g., consistent with cover 36) configured to close an access port 34 (FIG. 1C) in the fluid end block 18, and separating the component from the fluid end block 18 may include removing the cover 36 from the access port 34. In some embodiments, the method further may include positioning one of the component or another component relative to the fluid end block 18. For example, the component may include a cover 36 configured to close an access port 34 in the fluid end block 18, and positioning the one of the component or the other component relative to the fluid end block may include inserting the cover 36 (or a replacement cover) at least partially into the access port 34. In some embodiments, the method also may include, after engaging each of the plurality of second studs 74 in one of the plurality of anchor holes 90, sliding the outer housing 40 onto the second studs 74, thereby to position the outer housing 40 adjacent the fluid end block 18. In some embodiments, the method further may include engaging one of the retainer 48 or another retainer (e.g., a replacement retainer) with the outer housing 40, thereby to secure the component to the fluid end block 18.

According to some embodiments, for example, as shown in FIGS. 4A and 4B, a method for retrofitting a fluid end block 18 of a fluid end assembly 12 may include separating each of a plurality of fasteners 76 from each of a plurality of first studs 104 connecting a component to a fluid end block 18 of a fluid end assembly 12, as shown in FIG. 4A. In some embodiments, each of the plurality of first studs 104 may have a first anchor end 110 including first external anchor threads 108 having a buttress thread form, and a first fastener end 114 including first external fastener threads 112 having a buttress thread form. The method further may include separating each of the plurality of first studs 104 from each of a plurality of anchor holes 90 (see, e.g., FIG. 1C) in the fluid end block 18. In some embodiments, each of the anchor holes 90 may include internal anchor threads 88 having a buttress thread form. The method also may include, for example, as shown in FIG. 4B, engaging each of a plurality of second studs 74 in one of the plurality of anchor holes 90 in the fluid end block 18. In some embodiments, each of the plurality of second studs 74 may have a second anchor end 80 including second external anchor threads 86 having a buttress thread form, and a second fastener end 82 including second external fastener threads 92 having a thread form different than the second external anchor threads 86 of the second anchor ends 80 of each of the plurality of the second studs 74. The method further may include engaging each of a plurality of fasteners 76 with a second fastener end 82 of one of the plurality of second studs 74, thereby to connect the component (e.g., a cover 36) and the fluid end block 18 to one another.

In some embodiments, the method for retrofitting further may include, before separating each of the plurality of fasteners 76 from each of the plurality of first studs 104 (see, e.g., FIG. 4A), separating a retainer 48 preventing the component (e.g., a cover 36) from becoming separated from the fluid end block 18 from an outer housing 40 engaged with the retainer 48 and the fluid end block 18. In some embodiments, the method also may include, after separating each of the plurality of fasteners 76 from each of the plurality of first studs 104, sliding the outer housing 40 off the first studs 104, thereby to separate the outer housing 40 from the fluid end block 18. In some embodiments, the method further may include, before engaging each of the plurality of second studs 74 (see, e.g., FIG. 4B) in one of the plurality of anchor holes 90, separating the component from the fluid end block 18. In some embodiments, the component may include a cover 36 configured to close an access port 34 (see FIG. 1C) in the fluid end block 18, and separating the cover 36 from the fluid end block 18 may include removing the cover 36 from the access port 34. In some embodiments, the method further may include positioning one of the component or another component (e.g., the cover 36 or a replacement cover 36) relative to the fluid end block 18. For example, the component may include a cover 36 configured to close an access port 34 in the fluid end block 18, and positioning the one of the component or the other component relative to the fluid end block 18 may include inserting the cover 36 at least partially into the access port 34. In some embodiments, the method also may include, after engaging each of the plurality of second studs 74 in one of the plurality of anchor holes 90, sliding the outer housing 40 onto the second studs 74, thereby to position the outer housing 40 adjacent the fluid end block 18. In some embodiments, the method further may include engaging one of the retainer 48 or another retainer (e.g., a replacement retainer) with the outer housing 40, thereby to secure the component to the fluid end block 18.

### Testing

Tests were conducted to compare the preload as a function of input or tightening torque for two sets of sample studs: (1) the preload applied as a function of torque applied to a first set of ten identical sample studs, each including an example buttress thread form, and (2) the preload applied as a function of torque applied to a second set of ten identical sample studs, each including an example non-buttress thread form (i.e., a UNR thread form). The tested buttress thread form of the first set of sample studs was a 1.25-10 buttress thread. The tested non-buttress thread form of the second set of sample studs was a 1.25-8 UNR thread. In particular, Skidmore tests were performed on each of the sets of sample studs. Skidmore testing is a form of bolt testing where the fastener is inserted through the test apparatus and is then tightened against spacers, thereby compressing a load cell innate to the Skidmore tester. The resulting compression is shown on an analog gauge with resolution to the nearest 2,000 pound force (2 kips). Further determination of the preload values may require the subjective interpretation by the person performing the testing.

Skidmore testing was performed where a joint was designed to mimic the thickness of an example cover used to close an example access port of an example fluid end block, for example, as described herein. In a test of the first set of sample bolts (i.e., bolts having a buttress thread form at both ends), torque was applied to the sample bolts (each previously unused) using a standard tool and reaction washer. Torque was applied in increments of 100 foot-pounds (ft-lbs.) in a range from 700 ft-lbs. to 1600 ft-lbs. The results of the Skidmore testing for the first set of sample studs is provided in Table 1 below.

TABLE 1
Test Results for First Set of Sample Studs (Buttress Thread Form)

| Torque | Stud 1 | Stud 2 | Stud 3 | Stud 4 | Stud 5 | Stud 6 | Stud 7 | Stud 8 | Stud 9 | Stud 10 |
|---|---|---|---|---|---|---|---|---|---|---|
| ft-lbs. | kips | kips | kips | kips | kips | kips | kips | kips | kips | kips |
| 700 | 16 | 20 | 16 | 14 | 16 | 17 | 16 | 17 | 18 | 18 |
| 800 | 21 | 25 | 22 | 18 | 20 | 21 | 21 | 20 | 23 | 24 |
| 900 | 24 | 30 | 26 | 20 | 23 | 24 | 24 | 23 | 26 | 28 |
| 1000 | 26.5 | 34 | 30 | 24 | 26 | 28 | 28 | 26.5 | 30 | 32 |
| 1100 | 30 | 38 | 33 | 26 | 29 | 31 | 31 | 31 | 34 | 37 |
| 1200 | 32.5 | 41 | 36 | 29 | 32 | 35 | 35 | 35 | 38 | 41 |
| 1300 | 36.5 | 44.5 | 41 | 32 | 37 | 41 | 41 | — | 43 | 47 |
| 1400 | 40 | 48 | 46 | 36 | 41 | 46.5 | 46.5 | — | 48 | 52 |
| 1500 | 44 | 52 | 51 | 40 | 44 | 52 | 52 | 48 | 54 | 55 |
| 1600 | 48 | 54 | 58 | 46 | 52 | 57 | 57 | 56 | 58.5 | 59 |

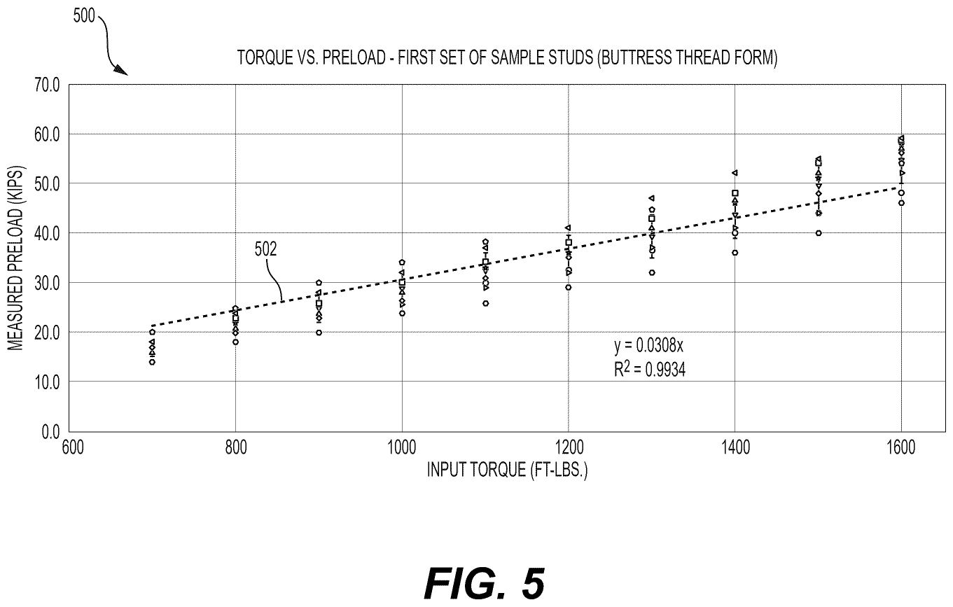

As shown in Table 1, the resulting preload levels are widely scattered for a given input torque across the ten sample studs of the first set of sample studs. FIG. 5 is a graph 500 showing a plot 502 of the results from Table 1 showing torque applied to the nut versus preload achieved for the first set of sample studs having the example buttress thread form. As shown by the plot 502 in FIG. 5, the resulting preload levels are widely scattered for a given input torque, where the different measured values for each of the sample studs for a given applied torque. These results in preload performance are significantly lower than the preload values that would normally be expected based on classical engineering calculations and an assumed coefficient of friction of 0.15 between the fastener (nut) and the prior art stud. For example, for a torque of 900 ft-lbs. applied to the fastener, a classical engineering calculation would predict the preload level to be about 60 kips. In contrast, the testing shows that the average measured preload level was only 24.9 kips, with a standard deviation of 2.8 kips. The maximum measured preload level at 900 ft-lbs. was 30 kips, and the minimum preload level was 20 kips. Thus, although the expected preload level at 900 ft-lbs. of torque was 60 kips, the actual measured preload was significantly below the expected pre-load level, at most only 50% of the expected preload level. Such a preload below the expected level of preload would result in the fastener being insufficiently preloaded, potentially leading to premature fatigue damage or failure of the prior art stud.

The second set of test sample studs included a classical UNR rolled thread form. Skidmore testing on the ten sample studs of the second set was preformed using the same representative joint used for the first set of ten sample studs. Torque was applied in the same manner. New sample studs, washers, and nuts were used for every test. Torque was applied in increments of 100 ft-lbs. from a range of 700 ft-lbs. until the measured preload level climbed above 90 kips. (This adjustment from previous testing protocol was made following the first sample stud achieving a preload of 97 kips at 1400 ft-lbs. and plastically deforming with the application of the next load step.) The results of the Skidmore testing for the second set of sample studs is provided in Table 2 below.

TABLE 2
Test Results for Second Set of Sample Studs (UNR Thread Form)

| Torque | Stud 1 | Stud 2 | Stud 3 | Stud 4 | Stud 5 | Stud 6 | Stud 7 | Stud 8 | Stud 9 | Stud 10 |
|---|---|---|---|---|---|---|---|---|---|---|
| ft-lbs. | kips | kips | kips | kips | kips | kips | kips | kips | kips | kips |
| 700 | 40 | 40 | 36 | 38 | 40 | 34 | 38 | 39 | 37 | 38 |
| 800 | 53 | 51 | 47 | 48 | 47 | 42 | 46 | 48 | 48 | 49 |
| 900 | 62 | 61 | 54 | 56 | 55 | 52 | 54 | 56 | 56 | 57 |
| 1000 | 68 | 68 | 62 | 64 | 62 | 60 | 60 | 62 | 63 | 63 |
| 1100 | 4 | 75 | 69 | 72 | 68 | 66 | 67 | 70 | 69 | 69 |
| 1200 | 80 | 80 | 74 | 78 | 74 | 72 | 76 | 76 | 76 | 76 |
| 1300 | 88 | 89 | 83 | 85 | 82 | 80 | 84 | 84 | 85 | 83 |
| 1400 | 97 | 96 | 92 | 92 | 88 | 88 | 91 | 93 | 93 | 91 |
| 1500 | Yielded | — | — | — | 96 | 94 | — | — | — | — |

As shown in Table 2, the second set of sample studs with the UNR thread form exhibited consistently tighter bands of variation than the first set of sample studs having the buttress thread form, thus, the preload level achieved was much more consistent. In particular, for the second set of sample studs, the average standard deviation of preload level decreased to 2.6 as compared to the first set of sample studs, which had an average standard deviation of preload level of 3.6.

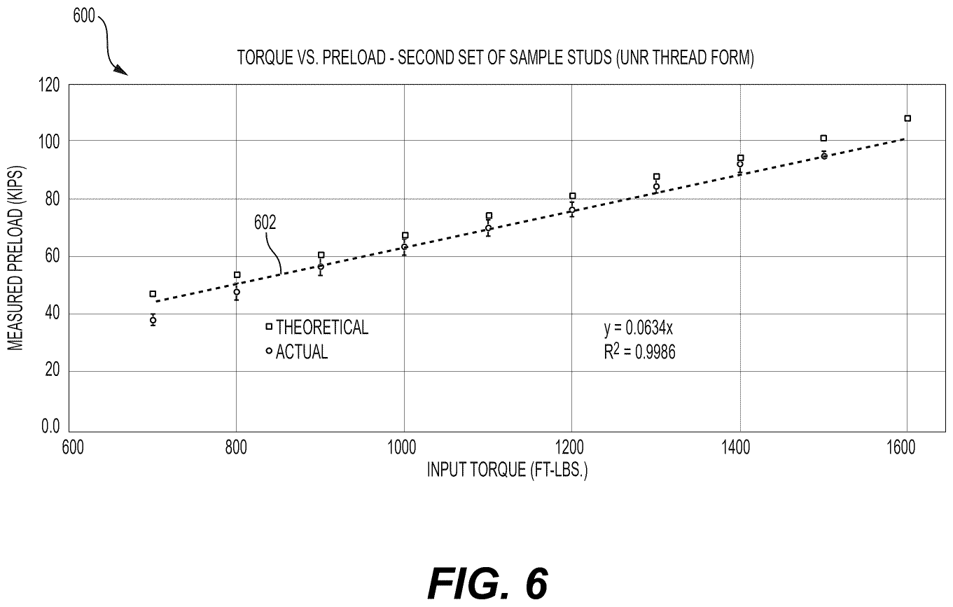

FIG. 6 is a graph 600 of the results from Table 2 showing a plot 602 of the torque applied to the fastener (nut) versus preload achieved for the second set of sample studs having the example UNR thread form. As shown by the plot 602 in FIG. 6, the resulting preload levels were much more consistent across the ten sample studs of the second set of samples. Thus, the second set of sample studs having the example tested UNR thread form performed significantly more consistently than the first set of sample studs having the example tested buttress thread form. The second set of sample studs also exhibited a preferable torque-to-preload relationship, for example, such that a desired torque of 900 ft-lbs. correlated to an average preload level of 57 kips, as compared to the expected preload level of 60 kips predicted by classical engineering calculations.

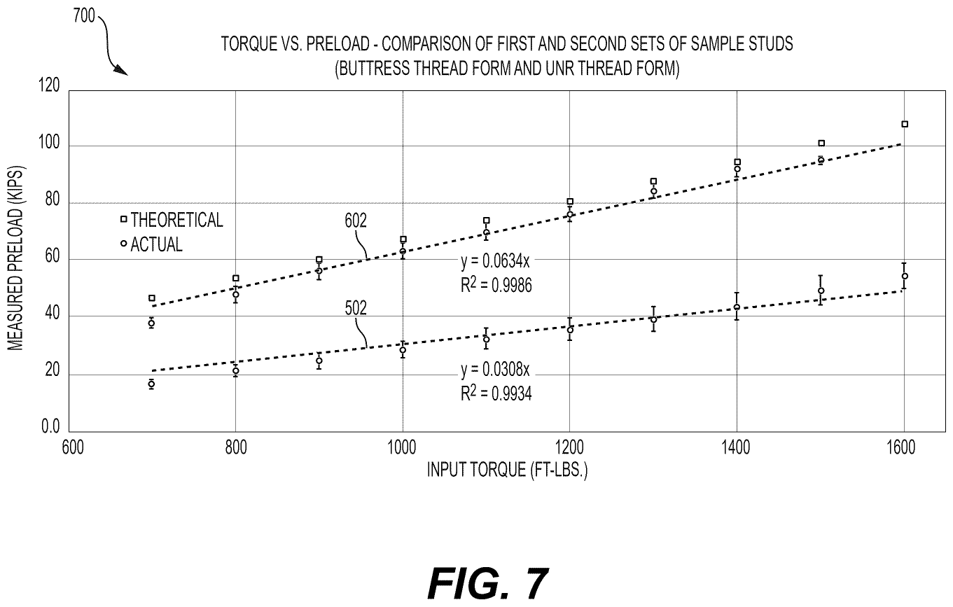

FIG. 7 is a graph 700 of the results from Table 1 and Table 2 showing a comparison of the plot 502 from FIG. 5 and the plot 602 from FIG. 6 of torque applied to the nut versus preload achieved for the first set of sample studs having the buttress thread form and the second set of sample studs having the example UNR thread form, respectively. As shown by a comparison of the plots 502 and 602 shown in FIG. 7, the second set of sample studs having the example UNR thread form (plot 602) exhibited a consistently higher preload level for every torque as compared to the first set of sample studs having the example buttress thread form (plot 502). Without wishing to be bound by theory, Applicant has surprisingly found that while the sample studs having the example UNR thread form consistently exhibit an average coefficient of friction of about 0.15, the sample studs having the example buttress thread form exhibit a widely varying coefficient of friction ranging from about 0.28 up to about 0.48, which is unexpected both in magnitude and breadth of variation. The relatively greater friction coefficient (in some instances more than twice) associated with the buttress thread form of the example prior art studs may be a factor in significantly reducing the preload level of the studs having the buttress thread form, for example, relative the example studs according to embodiments of the disclosure, having the example non-buttress thread form (e.g., the tested UNR thread form).

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/664,746, filed Jun. 27, 2024, titled “STUDS, ASSEMBLIES, AND METHODS PROVIDING ENHANCED RELIABILITY OF CONNECTIONS BETWEEN COMPONENTS IN HIGH-POWER PUMPS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A stud to enhance reliability of a connection between a component of a fluid end assembly and a fluid end block of the fluid end assembly, the stud comprising:
a stud body having a longitudinal stud axis extending between an anchor end positioned to be threadedly engaged with the fluid end block and a fastener end opposite the anchor end and positioned to be threadedly engaged with a fastener, thereby to secure the component and the fluid end block to one another, the stud body including:
a shank extending between the anchor end and the fastener end;
external anchor threads at the anchor end of the stud body, the external anchor threads having a buttress thread form positioned to engage internal threads of an anchor hole in the fluid end block having a complimentary internal buttress thread form, thereby to secure the anchor end of the stud body to the fluid end block; and
external fastener threads at the fastener end of the stud body, the external fastener threads having a thread form different than the external anchor threads of the anchor end of the stud body, the external fastener threads being positioned to engage internal threads of a fastener having a thread form complimentary to the thread form of the external fastener threads of the fastener end of the stud body, thereby to enhance reliability of a connection between the component and the fluid end block.

2. The stud of claim 1, wherein the external fastener threads comprise a thread form according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) the Deutsches Institut für Normung (DIN) standard; or (e) the American Petroleum Institute (API) standard.

3. The stud of claim 1, wherein the external fastener threads comprise a thread form according to one or more of UN thread form or UNR thread form as defined by one or more of the American National Standards Institute (ANSI) or the American Society of Mechanical Engineers (ASME).

4. The stud of claim 1, wherein the shank comprises one of: (a) a full-bodied shank having a shank diameter substantially equal to a major thread diameter of one or more of the external anchor threads or the external fastener threads; or (b) an undercut shank having a shank diameter substantially equal to or less than a pitch diameter of one or more of the external anchor threads or the external fastener threads.

5. A fluid end assembly for a high-power pump, the fluid end assembly comprising:
a fluid end block at least partially defining:
a chamber;
an access port providing access to the chamber; and
an anchor hole in an exterior face of the fluid end block and associated with the access port, the anchor hole having internal threads having a buttress thread form;
a cover at least partially received in the access port;
an outer housing connected to the cover, the outer housing having a housing hole extending through the outer housing;
a stud extending through the housing hole of the outer housing and into the anchor hole in the fluid end block, the stud comprising:
a stud body having a longitudinal stud axis extending between an anchor end threadedly engaged with the internal threads of the anchor hole and a fastener end opposite the anchor end and positioned to be threadedly engaged with a fastener, the stud body including:
a shank extending between the anchor end and the fastener end;
external anchor threads at the anchor end of the stud body, the external anchor threads having a buttress thread form engaging the internal threads of the anchor hole of the fluid end block, thereby to secure the anchor end of the stud body to the fluid end block; and
external fastener threads at the fastener end of the stud body, the external fastener threads having a thread form different than the external anchor threads of the anchor end of the stud; and
a fastener engaged with the fastener end of the stud body, the fastener having internal fastener threads complimentary to the external fastener threads of the fastener end of the stud body, thereby to enhance reliability of a connection between the cover, the outer housing, and the fluid end block.

6. The fluid end assembly of claim 5, wherein the outer housing at least partially defines a retainer aperture, and the fluid end assembly further comprises a retainer at least partially received in the retainer aperture, thereby to abut an exterior end of the cover so as to secure the cover at least partially in the access port.

7. The fluid end assembly of claim 6, wherein:
the retainer aperture includes interior retainer threads,
the retainer includes exterior retainer threads, and
the retainer is secured in the retainer aperture via threaded engagement between the interior retainer threads and the exterior retainer threads.

8. The fluid end assembly of claim 6, wherein:
the cover includes a cover body, the cover body including:
a port engaging portion;
a flange extending radially outward from the port engaging portion at the exterior end of the cover, and
a shoulder between an interior side of the flange and the port engaging portion; and
the retainer abuts the flange, thereby to secure the cover at least partially in the access port of the fluid end block.

9. The fluid end assembly of claim 5, wherein the fastener comprises a nut.

10. The fluid end assembly of claim 5, wherein:
the anchor hole comprises a plurality of anchor holes in the exterior face of the fluid end block,
the housing hole comprises a plurality of housing holes extending through the outer housing,
the stud comprises a plurality of studs, each of the plurality of studs extending through one of the plurality of housing holes and into one of the plurality of anchor holes in the exterior face of the fluid end block, and
the fastener comprises a plurality of fasteners, each of the plurality of fasteners being engaged with a respective fastener end of one of the plurality of studs, thereby to connect the cover, the outer housing, and the fluid end block to one another.

11. The fluid end assembly of claim 5, wherein the external fastener threads comprise a thread form according to one or more of: (a) the Unified Thread Standard (UTS) as defined by one or more of the American National Standards Institute (ANSI) or the American Society of Mechanical Engineers (ASME); or (b) metric screw threads as defined by the International Organization for Standardization (ISO).

12. The fluid end assembly of claim 5, wherein the external fastener threads comprise a thread form according to one or more of UN thread form or UNR thread form as defined by one or more of the American National Standards Institute (ANSI) or the American Society of Mechanical Engineers (ASME).

13. The fluid end assembly of claim 5, wherein the shank comprises one of: (a) a full-bodied shank having a shank diameter substantially equal to a major thread diameter of one or more the external anchor threads or the external fastener threads; or (b) an undercut shank having a shank diameter substantially equal to or less than a pitch diameter of one or more of the external anchor threads or the external fastener threads.

14. A high-power pump comprising:
a power end positioned to convert power into reciprocating motion;
a plunger connected to the power end and positioned to reciprocate; and
a fluid end assembly connected to the power end, the fluid end assembly comprising:
a fluid end block at least partially defining:
a chamber;
an access port providing access to the chamber; and
an anchor hole in an exterior face of the fluid end block and associated with the access port, the anchor hole having internal threads having a buttress thread form;
a cover at least partially received in the access port;
an outer housing connected to the cover, the outer housing having a housing hole extending through the outer housing;
a stud extending through the housing hole of the outer housing and into the anchor hole in the fluid end block, the stud comprising:
a stud body having a longitudinal stud axis extending between an anchor end threadedly engaged with the internal threads of the anchor hole and a fastener end opposite the anchor end and positioned to be threadedly engaged with a fastener, the stud body including:
a shank extending between the anchor end and the fastener end;
external anchor threads at the anchor end of the stud body, the external anchor threads having a buttress thread form engaging the internal threads of the anchor hole of the fluid end block, thereby to secure the anchor end of the stud body to the fluid end block; and
external fastener threads at the fastener end of the stud body, the external fastener threads having a thread form different than the external anchor threads of the anchor end of the stud; and
a fastener engaged with the fastener end of the stud body, the fastener having internal fastener threads complimentary to the external fastener threads of the fastener end of the stud body, thereby to enhance reliability of a connection between the cover, the outer housing, and the fluid end block.

15. A method of installing a cover in an access port of a fluid end block, the method comprising:
inserting a cover at least partially into an access port of a fluid end block;
positioning an outer housing adjacent an exterior face of the fluid end block and the cover;
passing an anchor end of a stud into a housing hole through the outer housing;
engaging external anchor threads of the anchor end of the stud with internal threads of an anchor hole in the exterior face of the fluid end block, the external anchor threads of the anchor end of the stud and the internal threads of the anchor hole having a buttress thread form; and
engaging internal threads of a fastener with external fastener threads of a fastener end of the stud, thereby to connect the cover, the outer housing, and the fluid end block to one another, the external fastener threads of the fastener end of the stud having a thread form different than the external anchor threads of the anchor end of the stud.

16. The method of claim 15, further comprising passing a retainer at least partially into a retainer aperture of the outer housing, thereby to abut an exterior end of the cover so as to secure the cover at least partially in the access port.

17. The method of claim 16, wherein the passing the retainer at least partially into the retainer aperture comprises engaging exterior retainer threads of the retainer with interior retainer threads in the retainer aperture.

18. A method for enhancing reliability of a connection between a component of a fluid end assembly and a fluid end block of the fluid end assembly, the method comprising:
separating each of a plurality of fasteners from each of a plurality of first studs connecting a component to a fluid end block of a fluid end assembly, each of the plurality of first studs having:
a first anchor end including first external anchor threads having a buttress thread form, and
a first fastener end including first external fastener threads having a buttress thread form;
separating each of the plurality of first studs from each of a plurality of anchor holes in the fluid end block, each of the anchor holes including internal anchor threads having a buttress thread form;
engaging each of a plurality of second studs in one of the plurality of anchor holes in the fluid end block, each of the plurality of second studs having:
a second anchor end including second external anchor threads having a buttress thread form, and
a second fastener end including second external fastener threads having a thread form different than the second external anchor threads of the second anchor ends of each of the plurality of the second studs; and
engaging each of a plurality of fasteners with a second fastener end of one of the plurality of second studs, thereby to enhance reliability of a connection between the component and the fluid end block.

19. The method of claim 18, further comprising, before separating each of the plurality of fasteners from each of the plurality of first studs, separating a retainer preventing the component from becoming separated from the fluid end block from an outer housing engaged with the retainer and the fluid end block.

20. The method of claim 19, further comprising, after separating each of the plurality of fasteners from each of the plurality of first studs, sliding the outer housing off the first studs, thereby to separate the outer housing from the fluid end block.

21. The method of claim 20, further comprising, before engaging each of the plurality of second studs in one of the plurality of anchor holes, separating the component from the fluid end block.

22. The method of claim 21, wherein the component comprises a cover configured to close an access port in the fluid end block, and separating the component from the fluid end block comprises removing the cover from the access port.

23. The method of claim 20, further comprising positioning one of the component or another component relative to the fluid end block.

24. The method of claim 23, wherein the component comprises a cover configured to close an access port in the fluid end block, and positioning the one of the component or the other component relative to the fluid end block comprises inserting the cover at least partially into the access port.

25. The method of claim 23, further comprising, after engaging each of the plurality of second studs in one of the plurality of anchor holes, sliding the outer housing onto the second studs, thereby to position the outer housing adjacent the fluid end block.

26. The method of claim 25, further comprising engaging one of the retainer or another retainer with the outer housing, thereby to secure the component to the fluid end block.

27. A method for retrofitting a fluid end block of a fluid end assembly, the method comprising:
separating each of a plurality of fasteners from each of a plurality of first studs connecting a component to a fluid end block of a fluid end assembly, each of the plurality of first studs having:
a first anchor end including first external anchor threads having a buttress thread form, and
a first fastener end including first external fastener threads having a buttress thread form;
separating each of the plurality of first studs from each of a plurality of anchor holes in the fluid end block, each of the anchor holes including internal anchor threads having a buttress thread form;
engaging each of a plurality of second studs in one of the plurality of anchor holes in the fluid end block, each of the plurality of second studs having:
a second anchor end including second external anchor threads having a buttress thread form, and
a second fastener end including second external fastener threads having a thread form different than the second external anchor threads of the second anchor ends of each of the plurality of the second studs; and
engaging each of a plurality of fasteners with a second fastener end of one of the plurality of second studs, thereby to enhance reliability of a connection between the component and the fluid end block.

28. The method of claim 27, further comprising, before separating each of the plurality of fasteners from each of the plurality of first studs, separating a retainer preventing the component from becoming separated from the fluid end block from an outer housing engaged with the retainer and the fluid end block.

29. The method of claim 28, further comprising, after separating each of the plurality of fasteners from each of the plurality of first studs, sliding the outer housing off the first studs, thereby to separate the outer housing from the fluid end block.

30. The method of claim 29, further comprising, before engaging each of the plurality of second studs in one of the plurality of anchor holes, separating the component from the fluid end block.

31. The method of claim 30, wherein the component comprises a cover configured to close an access port in the fluid end block, and separating the component from the fluid end block comprises removing the cover from the access port.

32. The method of claim 29, further comprising positioning one of the component or another component relative to the fluid end block.

33. The method of claim 32, wherein the component comprises a cover configured to close an access port in the fluid end block, and positioning the one of the component or the other component relative to the fluid end block comprises inserting the cover at least partially into the access port.

34. The method of claim 32, further comprising, after engaging each of the plurality of second studs in one of the plurality of anchor holes, sliding the outer housing onto the second studs, thereby to position the outer housing adjacent the fluid end block.

35. The method of claim 34, further comprising engaging one of the retainer or another retainer with the outer housing, thereby to secure the component to the fluid end block.
